(19) United States
(12) Patent Application Publication
(10) Pub. No.: US 2025/0375923 A1
(43) Pub. Date: Dec. 11, 2025

(54) MOLD POSITION ADJUSTING DEVICE AND MOLD OPENING METHOD

(71) Applicant: KING STEEL MACHINERY CO., LTD., TAICHUNG CITY (TW)

(72) Inventor: Fa-Shen CHEN, TAICHUNG CITY (TW)

(21) Appl. No.: 19/217,413

(22) Filed: May 23, 2025

Related U.S. Application Data
(60) Provisional application No. 63/656,683, filed on Jun. 6, 2024.

(51) Int. Cl. B29C 33/34; B29C 33/20

(52) U.S. Cl. CPC B29C 33/34; B29C 33/20

(57) ABSTRACT

A mold position adjusting device is provided on a vertical mold clamping device that has a first and a second mold base, wherein the first mold base is provided thereon with a first mold plate. The mold position adjusting device includes a pushing and turning mechanism and an expanding mechanism. The pushing and turning mechanism drives the first mold plate to turn between the two mold bases along an arc defined by a radius of gyration. The expanding mechanism drives the first mold base and/or the second mold base to move along a direction of gravity such that the two mold bases are spaced apart by a predetermined distance greater than the radius of gyration. With the two mechanisms providing the space required for turning the first mold plate, work safety requirements can be met without having to expand the existing warning area of the vertical mold clamping device.

### FIELD OF THE INVENTION

The present invention relates to a mold-based manufacturing technique. More particularly, the invention relates to a mold position adjusting device and a method of opening a mold.

### DESCRIPTION OF THE RELATED ART

Taiwan Utility Model Patent No. M513111U provides an upper mold base pushing and turning structure of a vertical mold clamping device. This pushing and turning structure is characterized mainly in that it can push an upper mold base out of a frame portion to facilitate an operator's operation. However, as the upper mold base will jut out of a projection zone defined by projecting the vertical mold clamping device vertically, the warning area of the vertical mold clamping device must be increased in size to ensure work safety.

Furthermore, if the vertical mold clamping device is additionally mounted with the vacuum enclosure assembly disclosed in Taiwan Utility Model Patent No. M551120, the vacuum enclosure will be in the pivoting path of the upper mold base, thus hindering the movement, and limiting the turning angle, of the upper mold base, making it impossible to move the upper mold base to the intended position; as a result, the execution of subsequent work will be affected. The prior art, therefore, demands improvement.

### SUMMARY OF THE INVENTION

The primary objective of the present invention is to provide a mold position adjusting device in which a pushing and turning mechanism and an expanding mechanism provide the space required for turning a first mold plate so that work safety requirements can be met without having to increase the extent of the existing warning area of a conventional vertical mold clamping device.

Another objective of the present invention is to provide a mold position adjusting device that can prevent a first mold plate from interference by an external component, in particular a vacuum enclosure, while the first mold plate is being turned.

To achieve the foregoing objectives, the present invention provides a mold position adjusting device to be provided on a vertical mold clamping device. The vertical mold clamping device has a first mold base and a second mold base, and the first mold base is provided thereon with a first mold plate. The mold position adjusting device includes a pushing and turning mechanism and an expanding mechanism. The pushing and turning mechanism is configured to drive the first mold plate to turn between the first mold base and the second mold base along an arc defined by a radius of gyration. The expanding mechanism is configured to drive the first mold base and/or the second mold base to move in a direction of gravity such that the first mold base and the second mold base are spaced apart by a predetermined distance that is greater than the radius of gyration.

In one embodiment, the expanding mechanism has a first actuating portion. The first actuating portion is connected to the first mold base and is configured to drive the first mold base close to or away from the second mold base.

In one embodiment, the expanding mechanism includes a second actuating portion. The second actuating portion is connected to the second mold base and is configured to drive the second mold base away from the first mold base.

In one embodiment, the expanding mechanism further includes a third actuating portion and a fourth actuating portion. The third actuating portion is connected to the second actuating portion and is configured to drive the second actuating portion to move between an operation position and a moved-away position along a horizontal direction perpendicular to the direction of gravity. When at the operation position, the second actuating portion is overlain by the second mold base in the direction of gravity. When at the moved-away position, the entire second actuating portion is outside a projection zone defined by projecting the vertical mold clamping device in the direction of gravity, and as a result, a recession space is formed in the projection zone defined by projecting the vertical mold clamping device in the direction of gravity. The fourth actuating portion is connected to the second mold base and is configured to drive the second mold base into the recession space along the direction of gravity.

In one embodiment, the pushing and turning mechanism has a pivot portion and a fifth actuating portion. The pivot portion is provided between the first mold plate and the first mold base and located on an end side of the first mold plate. The fifth actuating portion is connected to the first mold plate and is located on an opposite end side of the first mold plate. When the fifth actuating portion drives the first mold plate to move, the first mold plate is turned about an axis defined by the pivot portion.

In one embodiment, the pivot portion has a first pivot mount provided on the first mold base, a second pivot mount provided on the first mold plate, and an elongated swing arm. The elongated swing arm has two ends in its length direction, and each of these two ends is pivotally connected to one or the other of the first pivot mount and the second pivot mount.

In one embodiment, the pushing and turning mechanism includes a linkage portion and a sixth actuating portion. The linkage portion is connected to the first mold plate. The sixth actuating portion is connected to the linkage portion and is configured to drive the linkage portion into displacement and thereby drive the first mold plate away from or close to the first mold base.

In one embodiment, the pushing and turning mechanism further includes a first pivot portion, a second pivot portion, and a seventh actuating portion. The first pivot portion is provided between the first mold plate and the linkage portion and is located on an end side of the first mold plate. The second pivot portion is provided on an opposite end side of the first mold plate. The seventh actuating portion is connected to the first mold plate through the second pivot portion. When the seventh actuating portion drives the first mold plate to move, the first mold plate is turned about an axis defined by the first pivot portion and an axis defined by the second pivot portion.

In one embodiment, the first pivot portion has a first pivot mount provided on the linkage portion, a second pivot mount provided on the first mold plate, and an elongated swing arm. The elongated swing arm has two ends in its length direction, and each of these two ends is pivotally connected to one or the other of the first pivot mount and the second pivot mount.

The present invention further provides a mold opening method that is carried out as follows. While a vertical mold clamping device is being opened, a mold provided in the vertical mold clamping device is turned, along an arc defined by a radius of gyration, within a projection zone defined by projecting the vertical mold clamping device in a direction of gravity, and over the course in which the vertical mold clamping device is opened, an unused space extending across a predetermined distance in the direction of gravity remains in the space where the mold is located, wherein the predetermined distance is greater than the radius of gyration.

### BRIEF DESCRIPTION OF DRAWINGS

FIG. 1 schematically shows how the first embodiment of the present invention works.

FIG. 2 schematically shows the first embodiment of the present invention.

FIG. 3 schematically shows how the second embodiment of the present invention works.

FIG. 4 schematically shows the expanding mechanism in the third embodiment of the present invention and the corresponding linkage components.

FIG. 5 schematically shows how the third embodiment of the present invention works.

FIG. 6 schematically shows how the pushing and turning mechanism in the fourth embodiment of the present invention and the corresponding linkage components work.

FIG. 7 schematically shows how the second actuating portion in the fifth embodiment of the present invention and the corresponding linkage components work.

FIG. 8 schematically shows the sixth embodiment of the present invention.

### DETAILED DESCRIPTION OF THE INVENTION

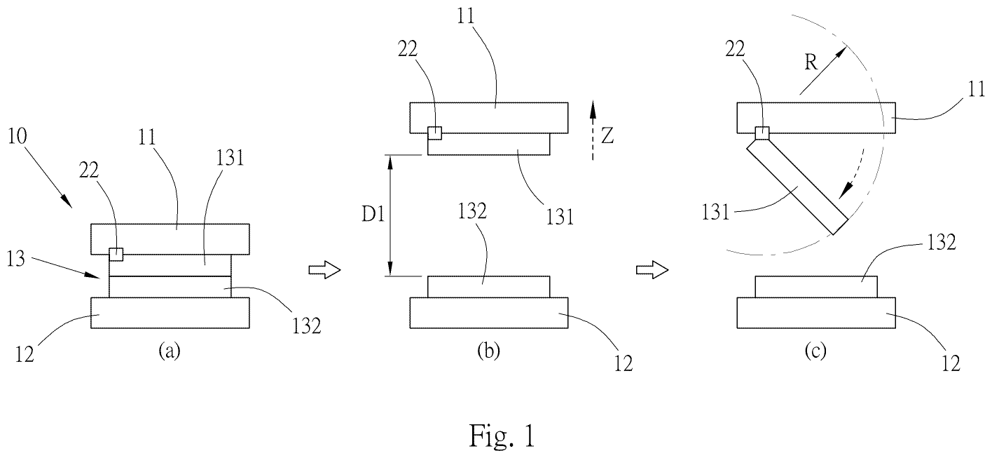

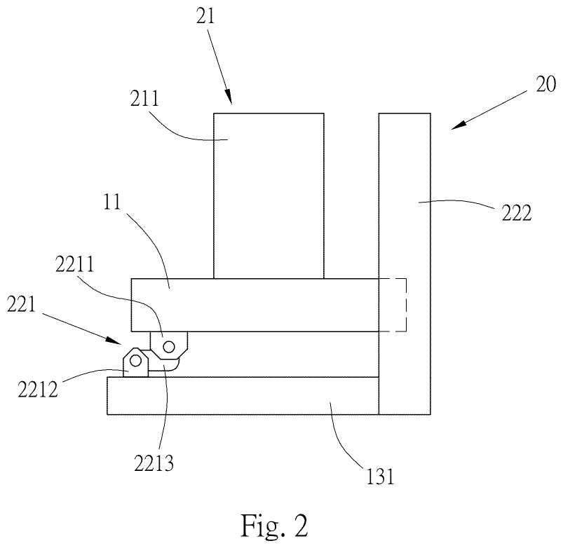

Referring to FIG. 1 and FIG. 2, the first embodiment of the present invention provides a mold position adjusting device 20. The mold position adjusting device 20 is provided on a vertical mold clamping device 10. The vertical mold clamping device 10 has a first mold base 11 and a second mold base 12 and is configured to support a mold 13. The mold 13 is a conventional mold 13 composed of a plurality of mold plates 131 that are vertically stacked and connected. In this embodiment, there are two mold plates, namely a first mold plate 131 and a second mold plate 132. The vertical mold clamping device 10 further includes a machine frame or a frame body and has appropriate supporting structures, such as guide rods, that, among other uses, allow the first mold base 11, the second mold base 12, or other components to be arranged, supported, and guided in a direction Z of gravity.

More specifically, the mold position adjusting device 20 includes an expanding mechanism 21 and a pushing and turning mechanism 22. The expanding mechanism 21 includes a first actuating portion 211. The first actuating portion 211 is a conventional driving element of the vertical mold clamping device 10 and provides the force required to open or close a mold. Generally, the first actuating portion 211 may be powered by a fluid pressure or electricity and has a force application end connected to the first mold base 11 either directly or indirectly via a toggle mechanism in order to apply a force to the first mold base 11 and thereby drive the first mold base 11 into movement along the direction Z of gravity, the objective being to displace the first mold base 11 back and forth between a first position as shown in FIG. 1(a) and a second position as shown in FIG. 1(b).

The pushing and turning mechanism 22 is configured to drive the first mold plate 131 to turn along an arc defined by a radius R of gyration, within a projection zone defined by projecting the vertical mold clamping device 10 in the direction Z of gravity, and between the first mold base 11 and the second mold base 12. In other words, the first mold plate 131 will be turned within the machine body of the mold clamping device 10. By contrast, the prior art requires the first mold plate 131 to be transversely moved out of the machine body of the mold clamping device 10 in order to be turned.

As shown in FIG. 2, the pushing and turning mechanism 22 has a pivot portion 221 and a fifth actuating portion 222. The pivot portion 221 is provided between the first mold plate 131 and the first mold base 11 and is located on an end side of the first mold plate 131. The pivot portion 221 has a first pivot mount 2211 provided on the first mold base 11, a second pivot mount 2212 provided on the first mold plate 131, and an elongated swing arm 2213. The elongated swing arm 2213 has two ends in its length direction, with one of the two ends pivotally connected to the first pivot mount 2211, and the other of the two ends pivotally connected to the second pivot mount 2212.

The fifth actuating portion 222 may be a hydraulic cylinder, is connected to the first mold plate 131, is located on the opposite end side of the first mold plate 131, i.e., the end side far from the pivot portion 221, and is configured to apply a force to the first mold plate 131 and thereby drive the first mold plate 131 to turn about an axis defined by the pivot portion 221, along an arc defined by the radius R of gyration, and between a third position and a fourth position. When the first mold plate 131 is at the third position, the upper end face of the first mold plate 131 lies against the first mold base 11, and when the first mold plate 131 is at the fourth position, the upper end face of the first mold plate 131 is far from the first mold base 11, with the first mold plate 131 and the first mold base 11 spaced apart by an appropriate turning angle. The magnitude of the turning angle is in direct proportion to an operator's ease of operation.

Given the foregoing components, implementation of the present invention leads to the following steps:

Step S101: Referring to FIG. 1(a), the first mold base 11 is at the first position, and the first mold plate 131 and the second mold plate 132 lie against, and are connected to, each other and are in a closed-mold state.

Step S102: Referring to FIG. 1(b), once the molding operation is completed, the first mold base 11 is driven by the first actuating portion 211 (not shown) to move from the first position to the second position, such that the first mold base 11 and the second mold base 12 are spaced apart by a predetermined distance D1. To facilitate description, the predetermined distance D1 is shown as defined between the opposing surfaces of the first mode plate 131 and the second mold plate 132. The predetermined distance D1, however, is not limited to this definition and may be defined between the opposing surfaces of the first mold base 11 and the second mold base 12 instead. The same applies to the definition of the mold opening distance in the following embodiments.

Step S103: Referring to FIG. 1(c), as the predetermined distance D1 is greater than the radius R of gyration, the first mold plate 131 is allowed to be driven by the fifth actuating portion 222 to move from the third position shown in FIG. 1(b) to the fourth position shown in FIG. 1(c), and during the process, the first mold plate 131 will not be interfered by other components, in particular the second mold base 12 and the second mold plate 132.

Thus, the present invention further provides a mold opening method that includes the step, to be performed while the vertical mold clamping device 10 is being opened, of turning the mold 13 provided in the vertical mold clamping device 10, with the mold 13 turned not only along an arc defined by the radius R of gyration, but also within the projection zone defined by projecting the vertical mold clamping device 10 in the direction Z of gravity. Moreover, while the vertical mold clamping device 10 is being opened, an unused space spanning the predetermined distance D1 in the direction Z of gravity remains in the space where the mold 13 is located, and the predetermined distance D1 is greater than the radius R of gyration.

In other words, in contrast to the prior art, the present invention allows a mold opening operation to be carried out, or more particularly allows the first mold plate to be turned within the unused space defined by the predetermined distance, in a way that does not require the existing warning area of the vertical mold clamping device to be increased in size but still meets work safety requirements.

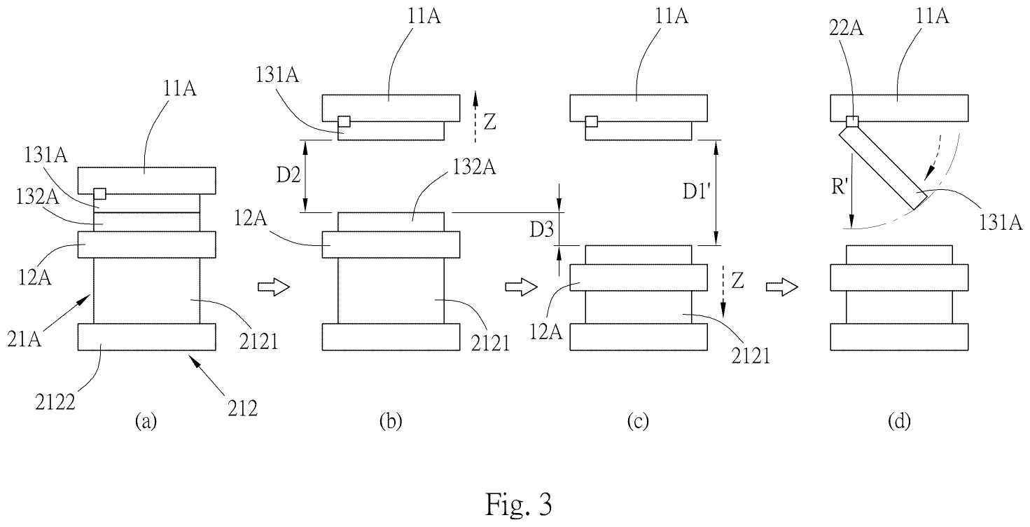

Referring to FIG. 3 for the second embodiment of the present invention, the second embodiment is different from the first embodiment mainly in two ways. First, the expanding mechanism 21A further includes a second actuating portion 212, and the second actuating portion 212 has at least one second power element 2121 and a base member 2122. The second power element 2121 is a known conventional driving element of the vertical mold clamping device 10, such as a hydraulic cylinder or motor powered by a fluid pressure or electricity, is provided on the base member 2122, and has a force application end connected to the second mold base 12A in a fixed or non-fixed manner so as to apply a force to the second mold base 12A and thereby drive the second mold base 12A into back-and-forth displacement between a fifth position, which is close to the first mold base 11A as shown FIG. 3(b), and a sixth position, which is far from the first mold base 11A as shown in FIG. 3(c), along the direction Z of gravity.

Second, once the first actuating portion has driven the first mold base 11A to arrive at the second position, the first mold base 11A and the second mold base 12A are spaced apart by a mold opening distance D2 less than the predetermined distance D1 in the previous embodiment.

Implementation of the second embodiment of the present invention leads to the following steps:

Step S201: Referring to FIG. 3(a), the first mold base 11A is at the first position, the second mold base 12A is at the fifth position, and the first mold plate 131A and the second mold plate 132A lie against, and are connected to, each other and are in a closed-mold state.

Step S202: Referring to FIG. 3(b), once the molding operation is completed, the first mold base 11A is driven by the first actuating portion 211A (not shown) to move upward by the mold opening distance D2 to the second position.

Step S203: Referring to FIG. 3(c), the second mold base 12A is driven by the second power element 2121 to move downward by a first receding distance D3 to the sixth position, such that the predetermined distance D1′ between the first mold base 11A and the second mold base 12A is the sum of the mold opening distance D2 and the first receding distance D3 and is greater than the radius R′ of gyration.

Step S204: Referring to FIG. 3(d), the first mold plate 131A is pivoted with respect to the first mold base 11A.

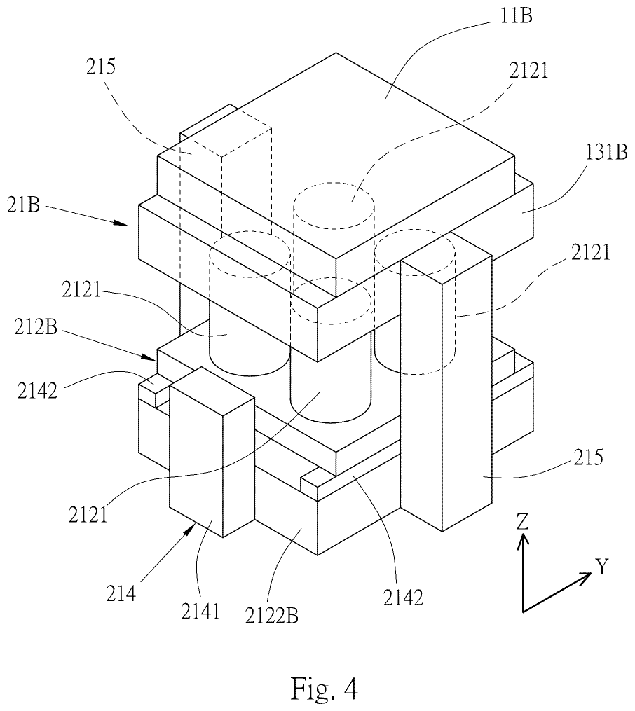

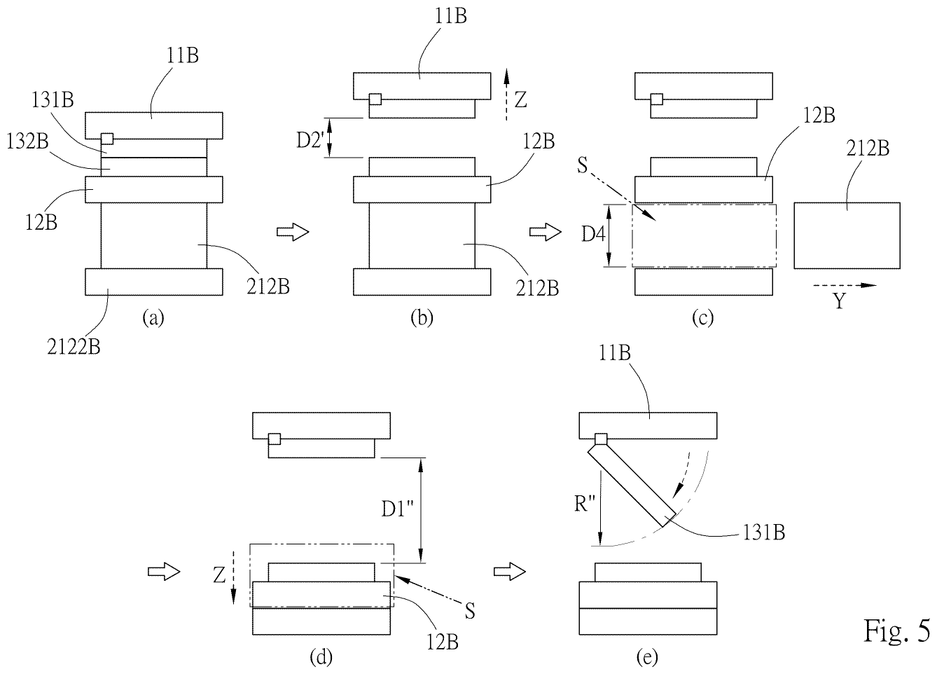

Referring to FIG. 4 for the third embodiment of the present invention, the third embodiment is different from the second embodiment mainly in that the expanding mechanism 21B further includes a third actuating portion 214 and a fourth actuating portion 215. The third actuating portion 214 has a third power element 2141 and two slide rails 2142. The slide rails 2142 are located between the base member 2122B and the second actuating portion 212B. The third power element 2141 is a conventional driving element such as a hydraulic cylinder or motor powered by a fluid pressure or electricity and has a force application end connected to the second actuating portion 212B in a fixed or non-fixed manner so as to apply a force to the second actuating portion 212B and thereby drive the second actuating portion 212B to move between an operation position and a moved-away position along a horizontal direction Y perpendicular to the direction Z of gravity. Referring to FIG. 5, when at the operation position, the second actuating portion 212B is overlain by the second mold base 12B in the direction Z of gravity, and when at the moved-away position, the entire second actuating portion 212B is outside the projection zone defined by projecting the vertical mold clamping device 10 in the direction Z of gravity, such that a recession space S is formed in the projection zone defined by projecting the vertical mold clamping device 10 in the direction Z of gravity.

The fourth actuating portion 215 is a conventional driving element such as a hydraulic cylinder or motor powered by a fluid pressure or electricity and has a force application end connected to the second mold base 12B in order to apply a force to the second mold base 12B and thereby drive the second mold base 12B into back-and-forth displacement between a seventh position and an eighth position along the direction Z of gravity. As shown in FIG. 5(a), the second mold base 12B is adjacent to the first mold base 11B when at the seventh position, and in consequence, the second mold plate 132B and the first mold plate 131B are closed. As shown in FIG. 5(d), the second mold base 12B is in the recession space S when at the eighth position.

Implementation of the third embodiment of the present invention leads to the following steps:

Step S301: Referring to FIG. 5(a), the first mold base 11B is at the first position, the second mold base 12B is at the seventh position, and the first mold plate 131B and the second mold plate 132B are in a closed-mold state.

Step S302: Referring to FIG. 5(b), once the molding operation is completed, the first mold base 11B is driven to move by the mold opening distance D2′ to the second position.

Step S303: The second actuating portion 212B is driven to move from the operation position shown in FIG. 5(b) to the moved-away position shown in FIG. 5(c).

Step S304: Referring to FIG. 5(d), the second mold base 12B is driven and controlled by the fourth actuating portion 215 (not shown) to move downward by a second receding distance D4 (which is equivalent to the height of the recession space S) to the eighth position, such that the first mold base 11B and the second mold base 12B are spaced apart by the predetermined distance D1″, wherein the predetermined distance D1″ is equivalent to the sum of the mold opening distance D2′ and the second receding distance D4 and is greater than the radius R″ of gyration. The technique by which the second mold base 12B is controlled to move by the second receding distance D4 may use a hydraulic cylinder as the power source, in order for the hydraulic cylinder to support the second mold base 12B at the seventh position when the recession space S is formed, and to apply a force to the second mold base 12B and thereby drive the second mold base 12B to move vertically back and forth between the seventh position and the eighth position.

Step S305: Referring to FIG. 5(e), the first mold plate 131B is pivoted with respect to the first mold base 11B.

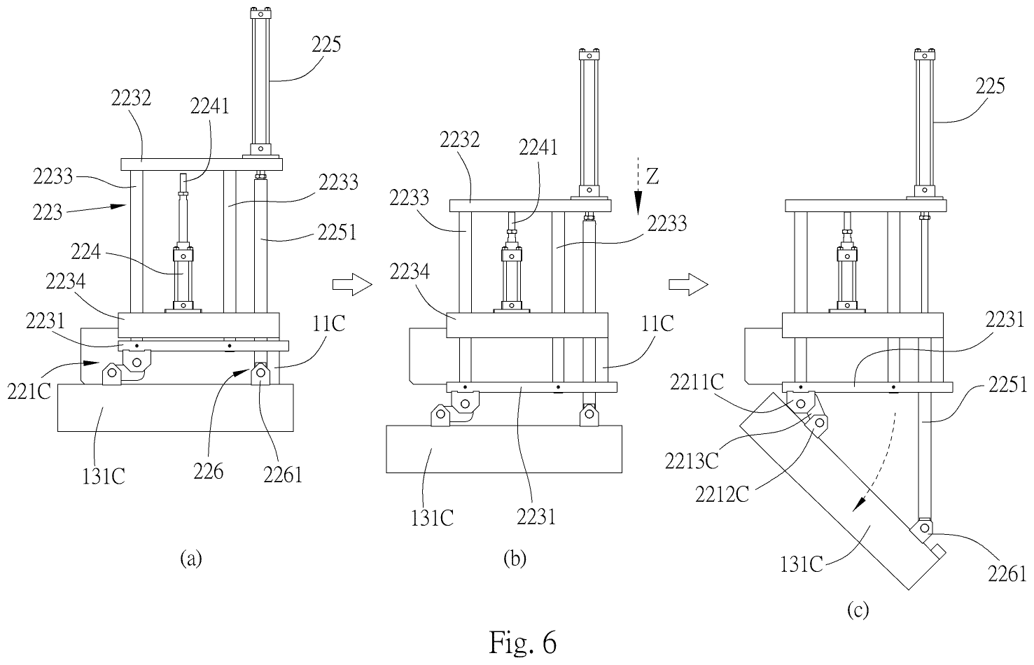

Referring to FIG. 6 for the fourth embodiment of the present invention, the fourth embodiment is different from the first embodiment mainly in the pushing and turning mechanism 22C, which includes a linkage portion 223, a first pivot portion 221C, a second pivot portion 226, a sixth actuating portion 224, and a seventh actuating portion 225.

The linkage portion 223 is connected to the first mold plate 131C. More specifically, the linkage portion 223 includes a first base portion 2231, a second base portion 2232, a guiding member 2233, and a sliding member 2234. The first base portion 2231 is connected to the first mold plate 131C. The second base portion 2232 is spaced apart from the first base portion 2231. The guiding member 2233 is provided between, and connects, the second base portion 2232 and the first base portion 2231. The sliding member 2234 is slidably provided on the guiding member 2233 and is connected to the first mold base 11C.

The sixth actuating portion 224 is a conventional driving element such as a hydraulic cylinder or motor powered by a fluid pressure or electricity and has a force application end 2241 connected to the linkage portion 223 in order to drive the linkage portion 223 into displacement, thereby driving the first mold plate 131C away from or close to the first mold base 11C, or more particularly displacing the first mold plate 131C back and forth between a ninth position as shown in FIG. 6(a) and a tenth position as shown in FIG. 6(b).

The first pivot portion 221C is provided between the first mold plate 131C and the linkage portion 223. More specifically, the first pivot portion 221C has a first pivot mount 2211C provided on the first base portion 2231, a second pivot mount 2212C provided on the first mold plate 131C and located on an end side of the first mold plate 131C, and an elongated swing arm 2213C. The elongated swing arm 2213C has two ends in its length direction, and each of these two ends is pivotally connected to one or the other of the first pivot mount 2211C and the second pivot mount 2212C.

The second pivot portion 226 has a third pivot mount 2261 provided on the first mold plate 131C. The third pivot mount 2261 is located on the opposite end side of the first mold plate 131C and is thus spaced apart from the second pivot mount 2212.

The seventh actuating portion 225 is a conventional driving element such as a hydraulic cylinder or motor powered by a fluid pressure or electricity and has a force application end 2251 pivotally connected to the third pivot mount 2261 provided on the first mold plate 131C, in order to drive the first mold plate 131C to turn about an axis defined by the first pivot portion.

The pushing and turning mechanism 22C in the fourth embodiment of the present invention works as follows. To start with, the sixth actuating portion 224 drives the linkage portion 223 and thereby moves the first mold plate 131C such that the relative positions of the first mold plate 131C and the first mold base 11C are changed; more particularly, the first mold plate 131C is moved away from the first mold base 11C along the direction Z of gravity, as shown in FIG. 6(a) to FIG. 6(b). Following that, referring to FIG. 6(c), the seventh actuating portion 225 drives the first mold plate 131C to pivot.

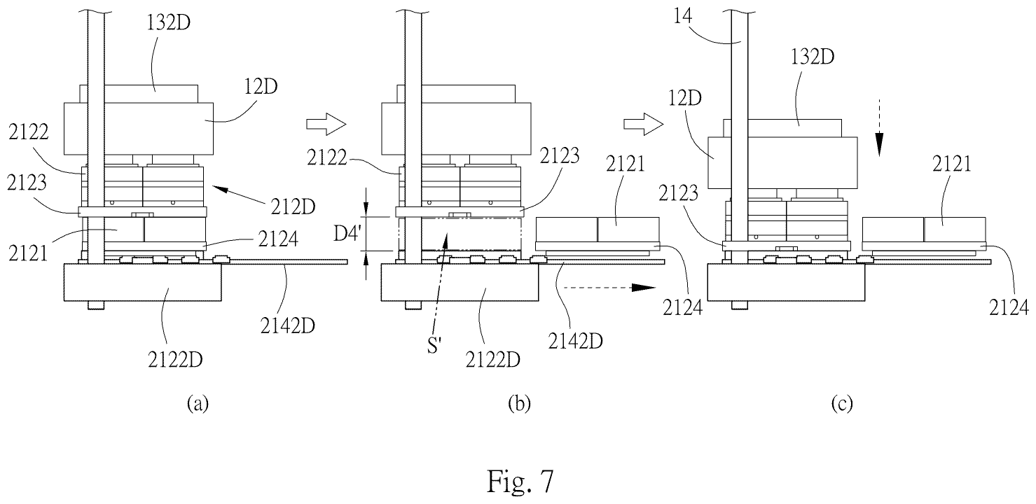

Referring to FIG. 7 for the fifth embodiment of the present invention, the fifth embodiment is different from the third embodiment in two ways. First, the second actuating portion 212D has, sequentially upward along the direction Z of gravity, a first carrying plate 2124, a first portion 2121, a second carrying plate 2123, and a second portion 2122 that are stacked together.

The first carrying plate 2124 is provided on the base member 2122D and carries the first portion 2121. The slide rails 2142D are provided between the base member 2122D and the first carrying plate 2124. The first carrying plate 2124 can be driven by the third power element (not shown) in order to be displaced back and forth between the operation position shown in FIG. 7(a) and the moved-away position shown in FIG. 7(b).

The second carrying plate 2123 is connected to a guide rod 14 of the vertical mold clamping device 10 in a way that ensures that the second carrying plate 2123 will stay stable, and move along a predetermined path, during the molding process. The second carrying plate 2123 carries the second portion 2122, the second mold base 12D, and the second mold plate 132D.

Second, as shown in FIG. 7(b), the height of the recession space S′ is equal to the thickness of the first portion 2121. The fourth actuating portion (not shown) can drive the second carrying plate 2123 to move by the second receding distance D4′, which is equivalent to the height of the recession space S′, from the seventh position shown in FIG. 7(b) to the eighth position shown in FIG. 7(c).

Thus, the fifth embodiment of the present invention can still provide an appropriate predetermined distance, allowing the first mold plate to be turned within the unused space defined by the predetermined distance.

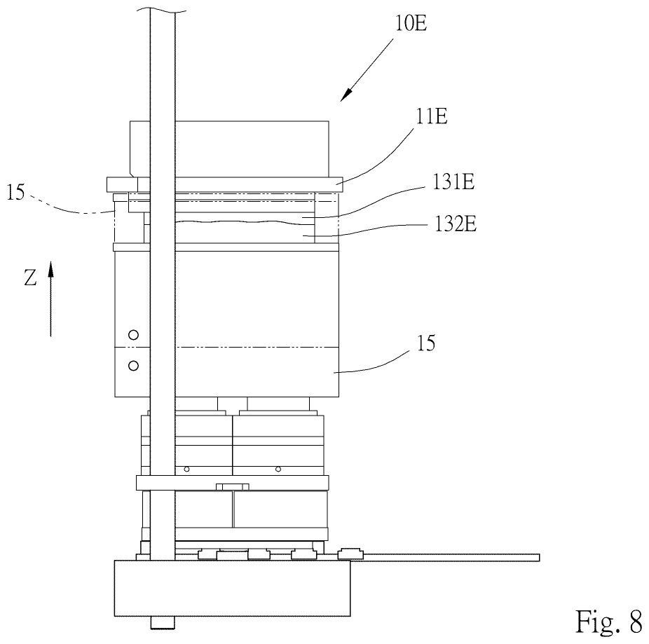

Referring to FIG. 8 for the sixth embodiment of the present invention, the sixth embodiment is different from the fifth embodiment in that the vertical mold clamping device 10E is further provided with a vacuum enclosure 15. The vacuum enclosure 15 is of a downward-moving type and can be moved back and forth between an opened position and a closed position along the direction Z of gravity by a driving unit (e.g., a hydraulic cylinder). When at the opened position, the vacuum enclosure 15 is far from the first mold base 11E and is below the second mold base. When at the closed position, the vacuum enclosure 15 covers the connected first mold bases 11E and second mold bases at the same time to isolate the mold bases from the outside, thereby allowing a subsequent vacuum operation to be performed.

In other feasible embodiments, the vacuum enclosure 15 may be of an upward-moving type instead. An upward-moving vacuum enclosure 15 is different from a downward-moving vacuum enclosure 15 mainly in that, when at the opened position, the upward-moving vacuum enclosure 15 is far from the second mold base 12E and is above the first mold base 11E.

Moreover, regardless of whether the vacuum enclosure 15 is a downward-moving or upward-moving vacuum enclosure, the mold position adjusting device (not shown) will not contact or otherwise interfere with the vacuum enclosure 15 at the opened position while driving the first mold plate 131E to turn.

What is claimed is:

1. A mold position adjusting device, to be provided on a vertical mold clamping device, wherein the vertical mold clamping device has a first mold base and a second mold base, and the first mold base is provided thereon with a first mold plate, the mold position adjusting device comprising:
a pushing and turning mechanism for driving the first mold plate to turn between the first mold base and the second mold base along an arc defined by a radius of gyration; and
an expanding mechanism for driving the first mold base and/or the second mold base to move along a direction of gravity such that the first mold base and the second mold base are spaced apart by a predetermined distance greater than the radius of gyration.

2. The mold position adjusting device of claim 1, wherein the expanding mechanism has a first actuating portion, and the first actuating portion is connected to the first mold base and is configured to drive the first mold base close to or away from the second mold base.

3. The mold position adjusting device of claim 1, wherein the expanding mechanism comprises a second actuating portion, and the second actuating portion is connected to the second mold base and is configured to drive the second mold base away from the first mold base.

4. The mold position adjusting device of claim 2, wherein the expanding mechanism comprises a second actuating portion, and the second actuating portion is connected to the second mold base and is configured to drive the second mold base away from the first mold base.

5. The mold position adjusting device of claim 3, wherein the expanding mechanism further comprises:
a third actuating portion connected to the second actuating portion and configured to drive the second actuating portion to move between an operation position and a moved-away position along a horizontal direction perpendicular to the direction of gravity, wherein when at the operation position, the second actuating portion is overlain by the second mold base in the direction of gravity, and when at the moved-away position, the second actuating portion is completely outside a projection zone defined by projecting the vertical mold clamping device in the direction of gravity, such that a recession space is formed in the projection zone defined by projecting the vertical mold clamping device in the direction of gravity; and
a fourth actuating portion connected to the second mold base and configured to drive the second mold base along the direction of gravity into the recession space.

6. The mold position adjusting device of claim 4, wherein the expanding mechanism further comprises:
a third actuating portion connected to the second actuating portion and configured to drive the second actuating portion to move between an operation position and a moved-away position along a horizontal direction perpendicular to the direction of gravity, wherein when at the operation position, the second actuating portion is overlain by the second mold base in the direction of gravity, and when at the moved-away position, the second actuating portion is completely outside a projection zone defined by projecting the vertical mold clamping device in the direction of gravity, such that a recession space is formed in the projection zone defined by projecting the vertical mold clamping device in the direction of gravity; and
a fourth actuating portion connected to the second mold base and configured to drive the second mold base along the direction of gravity into the recession space.

7. The mold position adjusting device of claim 1, wherein the pushing and turning mechanism has:
a pivot portion provided between the first mold plate and the first mold base and located on an end side of the first mold plate; and
a fifth actuating portion connected to the first mold plate and located on an opposite end side of the first mold plate, wherein when the fifth actuating portion drives the first mold plate to move, the first mold plate is turned about an axis defined by the pivot portion.

8. The mold position adjusting device of claim 7, wherein the pivot portion has:
a first pivot mount provided on the first mold base;
a second pivot mount provided on the first mold plate; and
an elongated swing arm having two ends in a length direction of the elongated swing arm, wherein each of the two ends is pivotally connected to one or the other of the first pivot mount and the second pivot mount.

9. The mold position adjusting device of claim 1, wherein the pushing and turning mechanism comprises:
a linkage portion connected to the first mold plate; and
a sixth actuating portion connected to the linkage portion and configured to drive the linkage portion into movement and thereby drive the first mold plate away from or close to the first mold base.

10. The mold position adjusting device of claim 9, wherein the pushing and turning mechanism further comprises:
a first pivot portion provided between the first mold plate and the linkage portion and located on an end side of the first mold plate;
a second pivot portion provided on an opposite end side of the first mold plate; and
a seventh actuating portion connected to the first mold plate through the second pivot portion, wherein when the seventh actuating portion drives the first mold plate to move, the first mold plate is turned about an axis defined by the first pivot portion and an axis defined by the second pivot portion.

11. The mold position adjusting device of claim 10, wherein the first pivot portion has:
a first pivot mount provided on the linkage portion;
a second pivot mount provided on the first mold plate; and
an elongated swing arm having two ends in a length direction of the elongated swing arm, wherein each of the two ends is pivotally connected to one or the other of the first pivot mount and the second pivot mount.

12. A mold opening method, comprising the step, to be performed while a vertical mold clamping device is being opened, of:
turning a mold provided in the vertical mold clamping device, such that the mold is turned, along an arc defined by a radius of gyration, within a projection zone defined by projecting the vertical mold clamping device in a direction of gravity, wherein while the vertical mold clamping device is being opened, an unused space spanning a predetermined distance in the direction of gravity remains in a space where the mold is located, and the predetermined distance is greater than the radius of gyration.
